(19) United States
(12) Patent Application Publication
(10) Pub. No.: US 2011/0199276 A1
(43) Pub. Date: Aug. 18, 2011

(54) Electromagnetic Radiation Guard

(76) Inventor: Eduard Gruzberg, Tiberius (IL)

(21) Appl. No.: 12/439,109

(22) PCT Filed: Nov. 2, 2008
(86) PCT No.: PCT/IL08/01436

§ 371 Date: Feb. 26, 2009

(51) Int. Cl. H01Q 17/00

(52) U.S. Cl. 343/841

(57) ABSTRACT

A device and a method for blocking RF radiation from a mobile phone are provided. The device comprises a hollow ferrite structure and a solenoid in a shortcut configuration having its terminals electrically coupled. The ferrite structure is shaped to match the part of the mobile phone and the antenna from which the RF radiation originates. The method comprises: providing a hollow ferrite structure with a solenoid in a short cut configuration located therein in close proximity to a mobile phone; converting RF radiation from the mobile phone into a first magnetic flux directed in 90° relative to the RF radiation; generating an electric current in response to the first magnetic flux; and generating a second magnetic flux directed in 90° relative to first magnetic flux resulting in canceling the RF radiation.

### CROSS-REFERENCE TO RELATED APPLICATION

This application is a National Stage of International Application no. PCT/IL2008/001436 filed Nov. 2, 2008, which is incorporated herein by reference in its entirety.

### TECHNICAL FIELD

The present invention relates generally to electromagnetic radiation safety devices, and more particularly, to safety devices arranged to protect from mobile phones radio frequency radiation.

### BACKGROUND OF THE INVENTION

Prior to setting forth the background of the invention in detail, it may be helpful to set forth definitions of certain terms that will be used hereinafter.

The term Radio Frequency (RF) as used herein in this application, is defined as frequencies of electromagnetic waves between approximately 3 kHz (3,000 Hz) and 300 GHz (3×10¹¹ Hz). Sometimes, a distinction is drawn between radio waves, which have frequencies between 3 kHz and 1 GHz, and microwaves, which have a frequency between 1 GHz and 300 GHz. Current mobile phones typically transmit low gain microwave radiation at 2.45 GHz.

The term Omni-Directional Antenna as used herein in this application, is defined as an antenna that radiates energy power more or less uniformly over an angle of 360 degrees in the horizontal plane around the antenna. Sometimes called a “low-gain” antenna and are typically used in mobile phones.

The term Power Flux—sometimes called “power density,” as used herein in this application, is defined as a measure of the radiated power reaching unit area of a surface. The accepted unit for this parameter is watts per square meter (W/m-sq).

The term SAR (Specific Absorption Rate) as used herein in this application, is defined as a measure of the rate at which electromagnetic energy is absorbed by an exposed object. SAR, measured in watts per kilogram (W/kg), is the basic quantity from which modern RF and MW safety criteria (exposure limits) are derived.

One of the ongoing concerns regarding mobile phones usage is the potential health related effects caused by prolonged exposure to radio frequency (RF) radiation in close proximity to the user's body.

Some devices for blocking or reducing RF radiation from mobile phones are known in the art. For example, some phone cases use the Faraday Cage principle, blocking altogether RF radiation (but disabling use thereof).

Other solutions are screen patches over the receiver region, clip-on antenna guards, antenna deflection devices, and remote headset apparatuses.

None of the aforementioned solutions provides a shield totally blocking RF radiation from the mobile phone in the user direction while maintaining regular operation of the mobile phone as a communication device.

### BRIEF SUMMARY

Accordingly, it is a principal object of the invention to overcome the disadvantages of the prior art. This is provided in the invention by an add-on device for blocking RF radiation from a mobile phone. The device comprises a hollow ferrite structure and a solenoid in a shortcut configuration—having its terminals electrically coupled. The ferrite structure is shaped to match the part of the mobile phone and the antenna from which the RF radiation originates. The size of the device is selected such that it blocks a spatial angle large enough to block RF radiation from at least the head of the user.

In embodiments of the invention there is further provided a method of blocking RF radiation from a mobile phone. The method comprises: providing a hollow ferrite structure with a solenoid in a short cut configuration located therein in close proximity to a mobile phone; converting RF radiation from the mobile phone into a first magnetic flux directed in 90° relative to the RF radiation; generating an electric current in response to the first magnetic flux; and generating a second magnetic flux directed in 90° relative to first magnetic flux resulting in canceling the RF radiation.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a high level schematic block diagram showing a device for blocking RF radiation from a mobile phone according to some embodiments of the invention;

FIG. 2 is a high level schematic block diagram showing device for blocking RF radiation from a mobile phone according to some embodiments of the invention;

FIG. 3 is a schematic vector diagram illustrating the operation of the device for blocking RF radiation according to some embodiments of the invention; and

FIG. 4 is a high level flow chart showing a method according to some embodiments of the invention.

The drawings together with the description make apparent to those skilled in the art how the invention may be embodied in practice.

### DETAILED DESCRIPTION OF SOME EMBODIMENTS OF THE INVENTION

Prior to setting forth a detailed description of some embodiments of the invention, it may be helpful to set forth definitions of certain terms that will be used hereinafter.

The term ferrite or alpha iron (α-Fe) as used herein in this application is defined as iron, or a solid solution with iron as the main constituent, with a body centered cubic crystal structure. It is the component which gives steel and cast iron their magnetic properties, and is the classic example of a ferromagnetic material.

The term solenoid as used herein in this application is defined as any three-dimensional coil made from a plurality of conductive loops. A solenoid in shortcut configuration is a solenoid with its terminals electrically coupled.

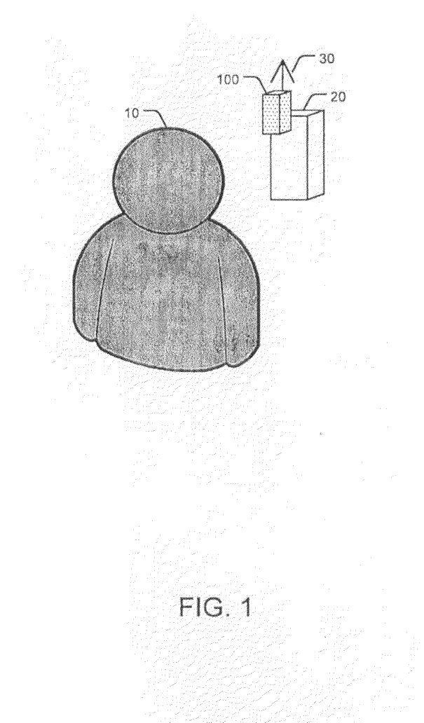

FIG. 1 shows a schematic diagram showing a device 100 for blocking RF radiation from a mobile phone. Device 100 is attached to a mobile phone 20 having wireless connectivity (hereinafter: phone) and an antenna 30 through which the RF radiation flows. Embodiments of the invention provide a directional RF shield functionality from RF microwave radiation originating in phone 20 while not disturbing the performance of the phone's operation.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

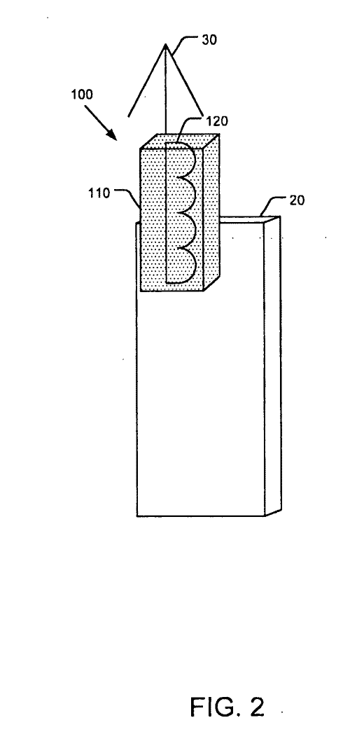

FIG. 2 shows a schematic diagram of device 100 for blocking RF radiation from a mobile phone according to the present invention. Device 100 comprises a hollow ferrite structure 110 and a solenoid 120 in a shortcut configuration—having its terminals electrically coupled. Ferrite structure is shaped to match the part of mobile phone 20 and antenna 30 from which the RF radiation originates. The size of device 100 is selected such that it blocks a spatial angle large enough to block RF radiation from at least the head of user 10.

According to some embodiments of the invention, device 100 may be adapted to any type of wireless handset: a land line cordless phone or a cellular communication device such as a mobile phone, a smart phone or a personal device accessory (PDA).

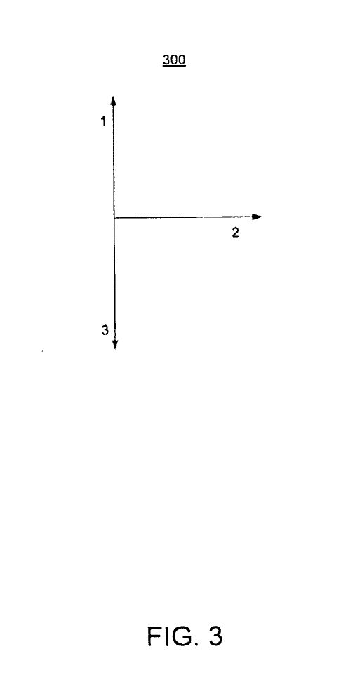

FIG. 3 shows a vector diagram showing the operation of device 100. In operation, mobile phone 20 produces RF radiation (vector 1) that serves as voltage field for ferrite structure 110. Due to the magnetic characteristic curve of ferrite, ferrite structure 110 converts the RF radiation (vector 1) into a first magnetic flux (vector 2) directed 90° relative to the RF radiation (vector 1). The loops of the solenoid 120 are located perpendicular to the first magnetic flux (vector 2) and thus solenoid 120 converts the first magnetic flux (vector 2) into an electrical current which generates in turn a second magnetic flux (vector 3) that is directed 90° relative to the first magnetic flux (vector 2) and 180° relative to RF radiation (vector 1). The second magnetic flux (vector 3) closes the magnetic flux loop within ferrite structure 110. The number of loops of solenoid 120 is selected such that vector 3 has the same absolute value as vector 1 and so these vectors cancel each other resulting in entirely blocking the RF radiation (vector 1) in the desired direction.

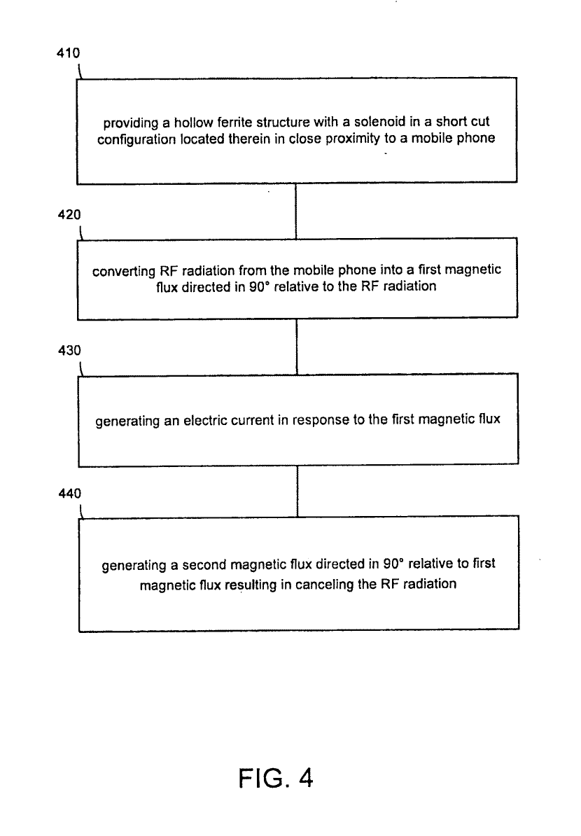

FIG. 4 shows a high level flowchart showing a method according to some embodiments of the invention. The method comprises: providing a hollow ferrite structure with a solenoid in a short cut configuration located therein in close proximity to a mobile phone 410; converting RF radiation from the mobile phone into a first magnetic flux directed in 90° relative to the RF radiation 420; generating an electric current in response to the first magnetic flux 430; generating a second magnetic flux directed in 90° relative to first magnetic flux resulting in canceling the RF radiation 440.

According to some embodiments of the invention, solenoid 120 may be arranged to have a variable inductivity that may be adjusted according to the operation frequency of the wireless phone.

According to some embodiments of the invention, device 100 may be embedded within a mobile phone having wireless connectivity as a standalone device.

According to some embodiments of the invention, device 100 further comprises a SAR indicator showing the RF radiation intensity in a use desired direction.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A device for blocking radio frequency microwave radiation from a mobile phone, the device comprising:
a hollow ferrite structure; and
a solenoid in a shortcut configuration located within the ferrite structure,
wherein the ferrite structure converts the RF radiation from the mobile phone into a first magnetic flux directed in 90° relative to the RF radiation; and
wherein the solenoid generates an electric current in response to the first magnetic flux; and
wherein the solenoid generates a second magnetic flux directed in 90° relative to first magnetic flux in response to the electric current resulting in canceling the RF radiation.

2. The device according to claim 1, wherein the ferrite structure is shaped to match the part of the mobile phone from which the RF radiation originates.

3. The device according to claim 1, wherein the size of the device is selected such that it blocks a spatial angle large enough to block RF radiation from at least the head of user.

4. The device according to claim 1, wherein the solenoid is configured to match an RF radiation at a frequency of approximately 2.45 GHz.

5. The device according to claim 1, wherein the solenoid has variable inductance that configured to match the RF radiation main frequency.

6. The device according to claim 1, wherein the solenoid comprises loops that are substantially perpendicular to direction of the first magnetic flux.

7. The device according to claim 1, wherein the device is embedded in a package of the mobile phone.

8. The device according to claim 1, further comprising a SAR level indicator.

9. A method of blocking radio frequency microwave radiation from a mobile phone, the method comprising:
providing a hollow ferrite structure with a solenoid in a short cut configuration located therein in close proximity to a mobile phone;
converting RF radiation from the mobile phone into a first magnetic flux directed in 90° relative to the RF radiation;
generating an electric current in response to the first magnetic flux;
generating a second magnetic flux directed in 90° relative to the first magnetic flux resulting in canceling the RF radiation.

10. The method according to claim 9, further comprising adjusting the solenoid inductance in according to RF radiation frequency of a particular mobile phone.

11. The method according to claim 9, further comprising presenting SAR levels at the radiation blocked area.

12. A mobile phone comprising:
an RF transceiver;
an antenna;
a hollow ferrite structure; and
a solenoid in a shortcut configuration located within the ferrite structure,
wherein the RF transceiver in cooperation with the RF antenna generates an RF radiation; and
wherein the ferrite structure is operatively associated with the antenna and converts the RF radiation from the antenna into a first magnetic flux directed in 90° relative to the RF radiation; and
wherein the solenoid generates an electric current in response to the first magnetic flux; and
wherein the solenoid generates a second magnetic flux directed in 90° relative to first magnetic flux in response to the electric current resulting in canceling the RF radiation.

13. The mobile phone according to claim 12, wherein the ferrite structure is shaped to match the part of the mobile phone from which the RF radiation flows.

14. The mobile phone according to claim 12, wherein the size of the device is selected such that it blocks a spatial angle large enough to block RF radiation from at least the head of user.

15. The mobile phone according to claim 12, wherein the solenoid is configured to match an RF radiation at a frequency of approximately 2.45 GHz.

16. The mobile phone according to claim 12, wherein the solenoid exhibits a variable inductance that is configurable to match the RF radiation main frequency.
